(19) United States
(12) Patent Application Publication
(10) Pub. No.: US 2011/0180678 A1
(43) Pub. Date: Jul. 28, 2011

(54) CARRYING DEVICE

(75) Inventor: Chang-Chan Liu, Jhonghe City (TW)

(73) Assignee: MULTISTAR INDUSTRIES CO., LTD., Taipei (TW)

(21) Appl. No.: 12/693,492

(22) Filed: Jan. 26, 2010

(51) Int. Cl. F16M 13/00; A44B 99/00

(52) U.S. Cl. 248/343; 24/458

(57) ABSTRACT

Fastening devices disposed on a housing. Each of the fastening devices has a base, a fastening piece, a clamping piece, and an elastic piece. The clamping piece swings toward the base, and then a jamming portion of the clamping piece fastens a fastening portion of the fastening piece such that the fastening piece can be located on a fastening position and the base can be covered with the clamping piece. When users push the housing and the fastening devices into a installation hole of the ceiling, two braking portions of the fastening piece are swung downwardly by colliding with the ceiling such that the clamping piece is resorted to original position to be located on a released position via the elastic piece, and the clamping piece is opened from the base, so that an abutting portion of the clamping piece abuts against the ceiling.

### BACKGROUND OF THE INVENTION

1. Field of the Invention

The present invention relates to a carrying device, in particular, to a carrying device is used to carry goods and install the goods on a ceiling via fastening devices disposed on a housing.

2. Description of Related Art

A traditional carrying device carrying goods such as speakers or lamps installs on a ceiling via screws to screw the traditional carrying device into the ceiling or via complex clips to clamp the traditional carrying device together with the ceiling.

However, it is not easy to install the traditional carrying device on the ceiling by the screws and the screws are exposed out of a surface of the traditional carrying device after installing. Moreover, an installation manner by suing the complex clips is of high cost and takes much time to install.

### SUMMARY OF THE INVENTION

In view of the aforementioned issues, the present invention provides a carrying device. The carrying device has a housing and fastening devices disposed on the housing. Because of an improvement of the fastening devices, the housing can be easily and rapidly installed on the ceiling and can be easily and rapidly dislodge from the ceiling for increasing the convenience of installation and for saving the time of installation.

Each of the fastening devices has a base, a fastening piece, a clamping piece, and an elastic piece. The clamping piece swings toward the base, and then a jamming portion of the clamping piece fastens a fastening portion of the fastening piece for fastening the clamping piece onto the base such that the fastening piece can be located on a fastening position and the base can be covered with the clamping piece.

When users push the housing and the fastening devices into a installation hole of the ceiling, two braking portions of the fastening piece are swung downwardly by colliding with the ceiling and the two braking portions drive the fastening portion to be rotated such that the fastening portion is parallel to a bottom wall of the base and the clamping piece is resorted to original position, so that an abutting portion of the clamping piece abuts against the ceiling. Thus, the fastening piece can be located on a released position and the clamping piece is opened from the base.

Two supporting portions of the base are fixed on the housing for supporting and carrying the housing and the goods carried by the housing. The housing, the two supporting portions, the abutting portion and the ceiling constitute a stable structure for installing and fixing the housing on the ceiling.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are provided solely for reference and illustration, without any intention that they be used for limiting the present invention.

### BRIEF DESCRIPTION OF THE DRAWINGS

FIG. 1A is a front view of a carrying device according to the present invention;

FIG. 1B is a lateral view of the carrying device according to the present invention;

FIG. 2 is a exploded view of each fastening device according to the present invention;

FIG. 3 is a assembled view of each fastening device according to the present invention;

FIG. 4 is a assembled view of a clamping piece of each fastening device fastening a fastening piece of each fastening device according to the present invention;

FIG. 5 is a cross-sectional view of the clamping piece fastening the fastening piece according to the present invention;

FIG. 6A is a schematic view of the carrying device before installing according to the present invention;

FIG. 6B is a schematic view of the carrying device for installing according to the present invention;

FIG. 6C is a schematic view of the carrying device after installing according to the present invention.

### DETAILED DESCRIPTION OF THE PREFERRED EMBODIMENTS

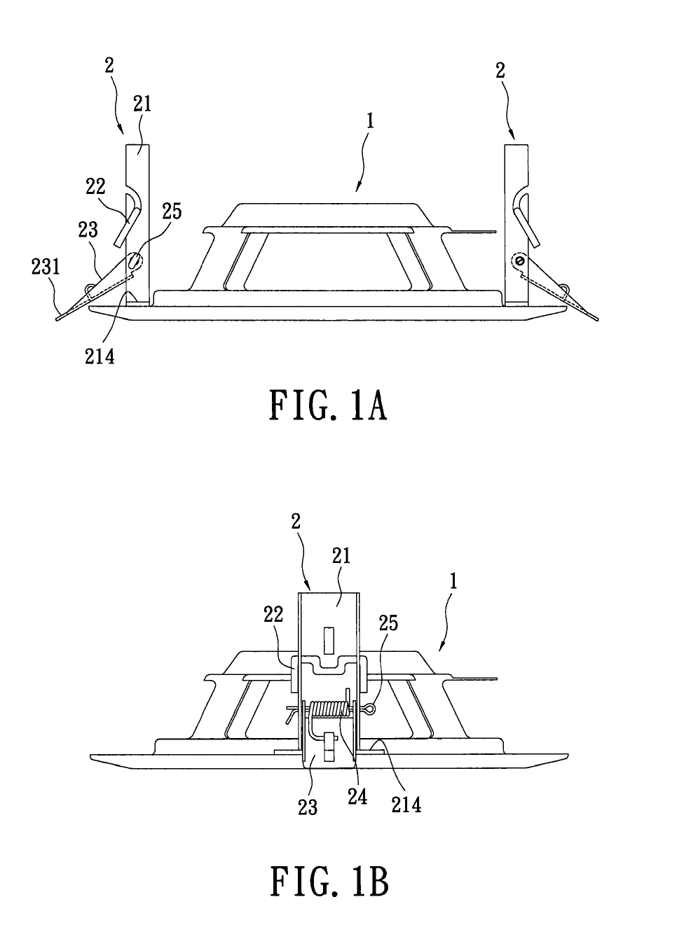

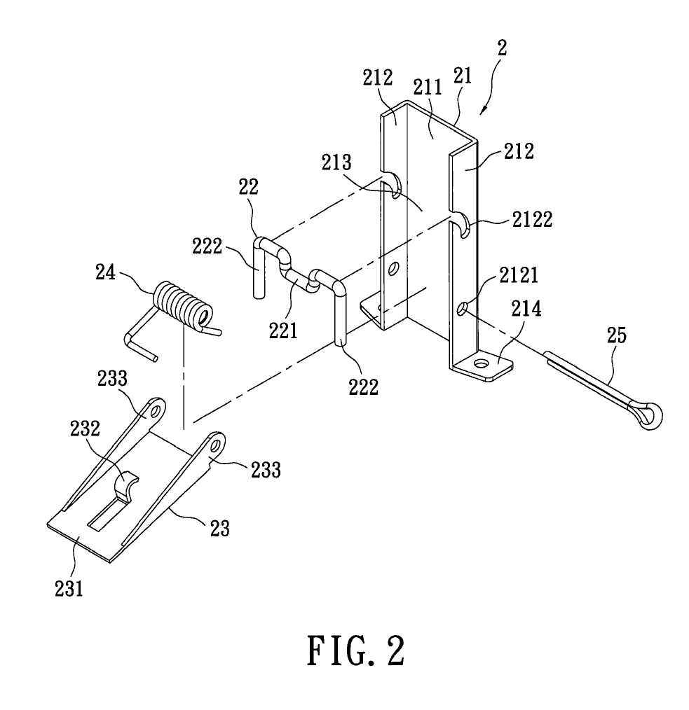

Referring to FIGS. 1A, 1B, 2 and 3, the present invention provides a carrying device, including a housing 1 and two fastening devices 2. The housing 1 is used to carry goods such as speakers or lamps and install and fix the goods on a ceiling. The two fastening devices 2 are respectively disposed on two sides of the housing 1.

Each of the fastening devices 2 has a base 21, a fastening piece 22, a clamping piece 23, an elastic piece 24 and a bolt 25. The base 21 has a bottom wall 211, two lateral walls 212, an accommodating space 213 and two supporting portions 214. The two lateral walls 212 are symmetrically disposed on two sides of the bottom wall 211. Each of the lateral walls 212 has a pivot hole 2121 and a positioning groove 2122. The two lateral walls 212 are essentially perpendicular to the bottom wall 211. The bottom wall 211 and the two lateral walls 212 define the accommodating space 213 for containing the fastening piece 22 and the elastic piece 24. The two lateral walls 212 respectively and outwardly extend to form one of the two supporting portions 214. The two supporting portions 214 are respectively disposed on the two sides of the housing 1, so that the two supporting portions 214 are used to support and carry the housing 1 and the goods carried by the housing 1.

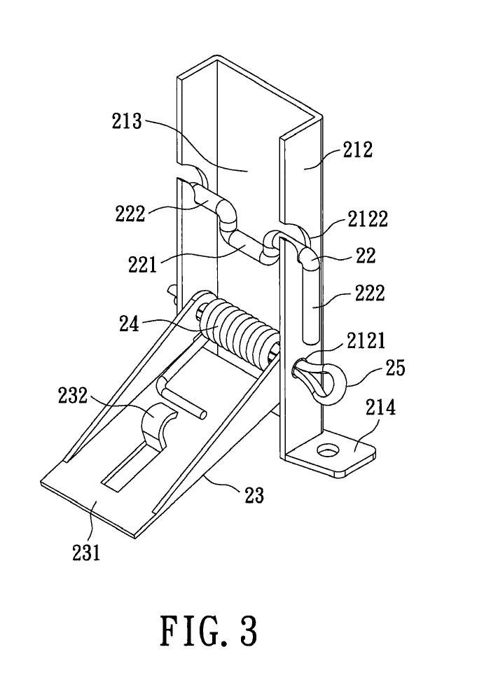

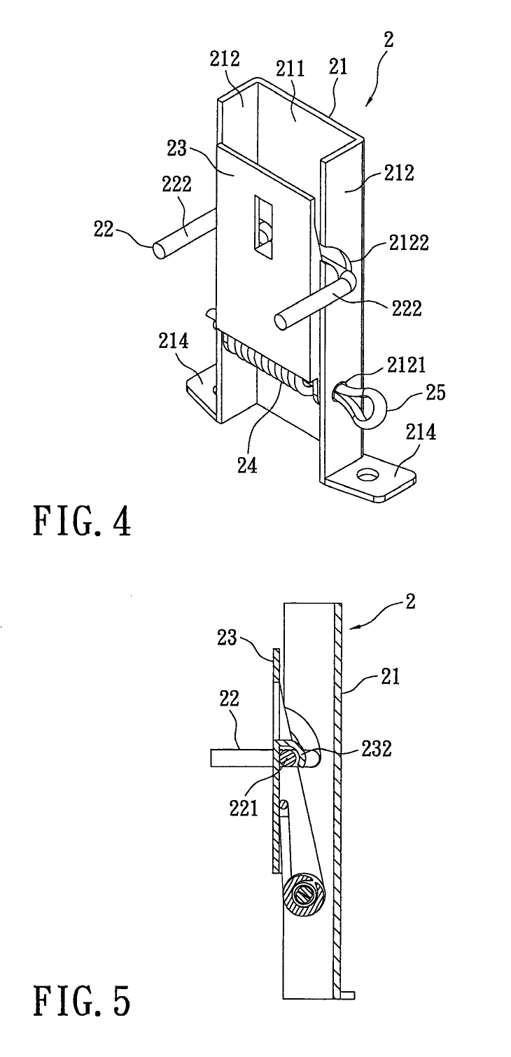

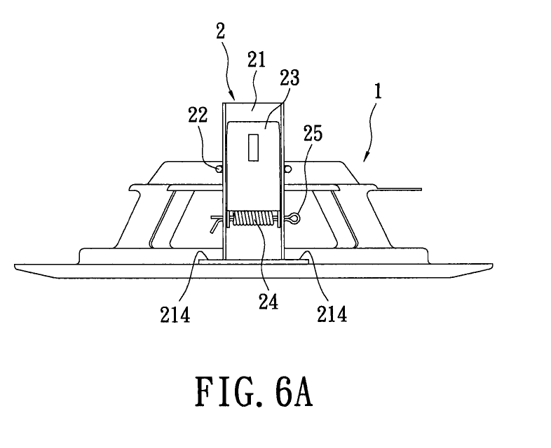

The fastening piece 22 is received in the accommodating space 213. Two ends of the fastening piece 22 are respectively put in the positioning grooves 2122 of the two lateral walls 212 and the fastening piece 22 is rotatably disposed on the base 21. The fastening piece 22 has a fastening portion 221 and two braking portions 222. Two ends of the fastening portion 221 respectively extend to form one of the two braking portions 222. The two braking portions 222 are integrally formed with the fastening portion 221. When the two braking portions 222 rotate relative to the base 21, the two braking portions 222 drive the fastening portion 221 to be rotated, so that the fastening portion 221 reversely protrudes from the bottom wall 211. For example, but not limited to, the fastening portion 221 rotates from a position which is parallel to the bottom wall 211 to another position which is perpendicular to the bottom wall 211. Thus, the fastening piece 22 may rotate between a released position (as shown in FIG. 3) and a fastening position (as shown in FIGS. 4 and 5).

The clamping piece 23 has an abutting portion 231, a jamming portion 232 and two pivoted portions 233. One end of the clamping piece 23 is pivoted on the base 21 and the other end of the clamping piece 23 slantly is extended to form the abutting portion 231. The abutting portion 231 and the two supporting portions 214 jointly constitute a stable structure (as shown in FIG. 3).

Two sides of the one end of the clamping piece 23 respectively extend to form the two pivoted portions 233 for pivoting the clamping piece 23 on the base 21, so that the clamping piece 23 can swing relative to the base 21. One face of the clamping piece 23 is provided with the jamming portion 232. The configuration of the jamming portion 232 correspondingly arranges to the configuration of the fastening portion 221, so that the jamming portion 232 of the clamping piece 23 can selectively fasten the fastening portion 221 of the fastening piece 22 (as shown in FIG. 5) and the two braking portions 222 are disposed on the base 21 in a manner like a cantilever beam. For example, but not limited to, the jamming portion 232 is a hook and the fastening portion 221 is a circular rod, so that the jamming portion 232 fastens the fastening portion 221 by combining the hook and the circular rod.

The elastic piece 24 is disposed between the base 21 and the clamping piece 23 and is received in the accommodating space 213. One end of the elastic piece 24 abuts against the base 21 and the other end of the elastic piece 24 abuts against the clamping piece 23. When the clamping piece 23 swings relative to the base 21, the elastic piece 24 disposed between the base 21 and the clamping piece 23 produces elastic restoring forces acting on the clamping piece 23. For example, the clamping piece 23 swings toward the base 21 via a rotation shaft such as the bolt 25 (as shown in FIG. 4), the elastic piece 24 is deformed and produces the elastic restoring forces. However, the elastic piece 24 of the present invention includes but is not limited to a torsion spring. The elastic piece 24 also can be a tension spring, a compression spring, a winding spring or an improved spring which has laid-open or been used.

The bolt 25 penetrates through the pivot holes 2121 of the two lateral walls 212 of the base 21, the two pivoted portions 233 of the clamping piece 23, and the elastic piece 24, so that the elastic piece 24 sleeves around the bolt 25. Otherwise, the number of the fastening devices 2 may be three, four, or more than four. Those fastening devices 2 are spacedly disposed on a periphery of the housing for stably carrying the housing 1 and the goods carried by the housing 1.

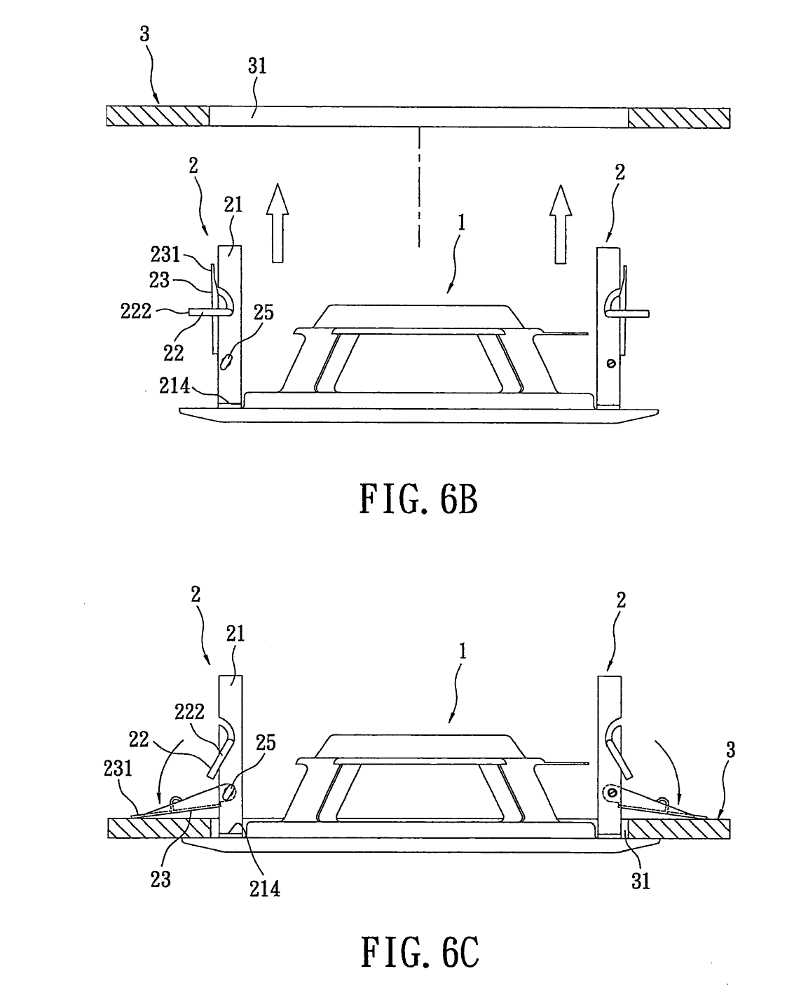

Because of an improvement of the fastening devices 2 of the present invention, the housing 1 can be easily and rapidly installed on the ceiling 3 and can be easily and rapidly dislodge from the ceiling 3 for increasing the convenience of installation and for saving the time of installation. Referring to FIGS. 6A to 6C, the clamping piece 23 firstly swings toward the base 21, and then the jamming portion 232 fastens the fastening portion 221 for fastening the clamping piece 23 onto the base 21 such that the fastening piece 22 can be located on the fastening position and the base 21 can be covered with the clamping piece 23 (as shown in FIG. 6A). The two braking portions 222 disposed on the base 21 are rotated and disposed on the base 21 in a manner like a cantilever beam.

To follow, the users push the housing 1 and the two fastening devices 2 into an installation hole 31 of the ceiling 3 (as shown in FIG. 6B). The two braking portions 222 are swung downwardly by colliding with the ceiling 3 (as shown in 6C) and the two braking portions 222 drive the fastening portion 221 to be rotated such that the fastening portion 221 is parallel to the bottom wall 211 of the base 21 and the clamping piece 23 is resorted to original position, so that the abutting portion 231 abuts against the ceiling 3. Thus, the fastening piece 22 can be located on the released position and the clamping piece 23 is opened from the base 21.

For installing, the abutting portion 231 of the clamping piece 23 can automatically abut against the ceiling 3 due to the fastening piece 22 collides with the ceiling 3. The two supporting portions 214 of the base 21 are fixed on the housing 1 for supporting and carrying the housing 1 and the goods carried by the housing 1. The abutting portion 231 of the clamping piece 23 is used to abut and compress the ceiling 3, so that the housing 1 and the abutting portion 231 jointly clamp the ceiling 3 such that the housing 1, the two supporting portions 214, the abutting portion 231 and the ceiling 3 constitute a stable structure for installing and fixing the housing 1 on the ceiling 3.

In conclusion, the present invention has following advantages:
1. In order to the housing 1 can be easily and rapidly installed on the ceiling 3 and can be easily and rapidly dislodge from the ceiling 3 for increasing the convenience of installation and for saving the time of installation, the abutting portion 231 of the clamping piece 23 can automatically abut against the ceiling 3 due to the fastening piece 22 collides with the ceiling 3.
2. The two supporting portions 214, the abutting portion 231 and the ceiling 3 constitute a stable structure for installing and fixing the housing 1 on the ceiling 3.

The above-mentioned descriptions merely represent solely the preferred embodiments of the present invention, without any intention or ability to limit the scope of the present invention which is fully described only within the following claims. Various equivalent changes, alterations or modifications based on the claims of present invention are all, consequently, viewed as being embraced by the scope of the present invention.

What is claimed is:

1. A carrying device comprising:
a housing; and
two fastening devices disposed on the housing, each of the fastening devices comprising:
a base having a bottom wall, two lateral walls, and an accommodating space, the two lateral walls symmetrically disposed on two sides of the bottom wall, the accommodating space defined by the bottom wall and the two lateral walls;
a clamping piece pivoted on the base and having a jamming portion;
an elastic piece received in the accommodating space, one end of the elastic piece abutting against the base and the other end of the elastic piece abutting against the clamping piece; and
a fastening piece received in the accommodating space, the fastening piece having a fastening portion correspondingly arranging to the jamming portion, the fastening piece rotatably disposed on the base and rotated between a released position and a fastening position, so that the jamming portion of the clamping piece selectively fastens the fastening portion of the fastening piece, wherein the base is covered with the clamping piece due to the fastening piece located on the fastening position and the clamping piece is opened from the base due to the fastening piece located on the released position.

2. The carrying device according to claim 1, wherein the fastening piece has two braking portions respectively extended from two ends of the fastening piece.

3. The carrying device according to claim 2, wherein the braking portions rotate relative to the base and drive the fastening portion rotated, so that the fastening portion reversely protrudes from the bottom wall and the jamming portion fastens the fastening portion.

4. The carrying device according to claim 2, wherein the braking portions are disposed on the base in a manner like a cantilever beam and the jamming portion fastens the fastening portion.

5. The carrying device according to claim 2, wherein the jamming portion is a hook and the fastening portion is a circular rod.

6. The carrying device according to claim 1, wherein the base has two supporting portions respectively and outwardly extended from the two lateral walls and the clamping piece has an abutting portion slantly extended from the clamping piece.

7. The carrying device according to claim 6, wherein the housing and the abutting portion jointly clamp a ceiling and the housing carrying goods install and fix on the ceiling by a stable structure constituted by the housing, the supporting portions, the abutting portion, and the ceiling.

8. The carrying device according to claim 7, wherein the goods are speakers or lamps.

9. The carrying device according to claim 3, wherein the base has two supporting portions respectively and outwardly extended from the two lateral walls and the clamping piece has an abutting portion slantly extended from the clamping piece.

10. The carrying device according to claim 9, wherein the housing and the abutting portion jointly clamp a ceiling and the housing carrying goods install and fix on the ceiling by a stable structure constituted by the housing, the supporting portions, the abutting portion, and the ceiling.

11. The carrying device according to claim 10, wherein the goods are speakers or lamps.

12. The carrying device according to claim 1, wherein the elastic piece is a torsion spring, a tension spring, a compression spring, or a winding spring.

13. The carrying device according to claim 3, wherein the elastic piece is a torsion spring, a tension spring, a compression spring, or a winding spring.

14. The carrying device according to claim 7, wherein the elastic piece is a torsion spring, a tension spring, a compression spring, or a winding spring.
